(19) United States
(12) Patent Application Publication
(10) Pub. No.: US 2009/0225887 A1
(43) Pub. Date: Sep. 10, 2009

(54) Multi-carrier data communication with repetition of some data at a frequency separation to provide an artificial cyclostationary signature

(76) Inventor: Paul David Sutton, County Cork (IE)

Correspondence Address: JACOBSON HOLMAN PLLC, 400 SEVENTH STREET N.W., SUITE 600, WASHINGTON, DC, 20004, US

(21) Appl. No.: 12/379,584

(22) Filed: Feb. 25, 2009

Related U.S. Application Data
(60) Provisional application No. 61/064,279, filed on Feb. 26, 2008.

(51) Int. Cl. H04B 7/02

(52) U.S. Cl. 375/267

(57) ABSTRACT

A cyclostationary signature is artificially created in a multi-carrier signal. In one embodiment, a multi-carrier Orthogonal Frequency Division Multiplexing (OFDM) signal is used. The approach involves mapping a set of one or more of the sub-carriers onto a second set such that any data symbols transmitted on the first set is are simultaneously transmitted on the second set. In this way, those spectral components of the signal will be identical and a spectral correlation pattern will have been created. This spectral correlation pattern comprises the cyclostationary signature. An artificial cyclostationary signature embedded in this way is continuously present in the transmitted data-carrying signal and so can be considered a type of signal watermark. By detecting and examining this watermark, a communications receiver can determine key properties of the signal and use those properties to achieve a number of critical tasks.

### INTRODUCTION

1. Field of the Invention

The invention relates to multi-carrier data communication, such as the Orthogonal Frequency Division Multiplexing (OFDM) communication scheme.

2. Prior Art Discussion

As data communication systems advance, they are becoming increasingly flexible and adaptive. Rather than employing static, fixed operating parameters, communication systems are permitting operating parameters to be dynamically adapted and reconfigured in response to changing operating conditions. In this way, these systems attempt to maximize throughput while using the resources available in the most efficient manner possible.

A significant challenge associated with this increase in operating parameter flexibility is that of rendezvous and coordination. A communication system comprises a number of nodes wishing to communicate. In order for these nodes to establish communication links, a compatible set of operating parameters must be used by each. The process of network rendezvous and coordination involves agreement upon suitable operating parameters to be used by devices within the network.

While coordination within individual communication systems is essential, increasing levels of coordination between different communications systems are becoming necessary. This is especially the case where systems must share a common communications medium such as a radio frequency band, cable, or fibre.

In order to facilitate coordination in advanced communication systems, techniques are required which permit nodes to derive useful information about a communications signal with limited prior knowledge of the operating parameters used to generate that signal. A powerful technique for the analysis of signals whose properties are unknown is cyclostationary signal analysis. Many of the communication signals in use today exhibit periodicities of their second order statistical parameters due to the coupling of stationary message signals with periodic sine wave carriers, pulse trains or repeating spreading codes and operations such as sampling, scanning, multiplexing and coding. These cyclostationary properties give rise to unique spectral correlation features which may be detected through the use of appropriate nonlinear transformations. An overview of cyclostationary signal analysis and its uses can be found at Reference [1].

One example of a commonly used multi-carrier transmission scheme is Orthogonal Frequency Division Multiplexing (OFDM). OFDM is a highly effective scheme for high data-rate communications systems which has been adopted in a wide variety of commercial systems including digital subscriber lines, wireless LANs (IEEE 802.11a/g/n WiFi), digital video broadcasting (DVB) and wireless MANs (IEEE 802.16 WiMAX). A key reason for its popularity is the availability of efficient digital implementations and the manner in which it can be used to overcome inter-symbol interference (ISI).

OFDM is a multi-carrier modulation scheme in which a high-rate data stream is divided into a number of parallel lower-rate substreams. These substreams are then transmitted over a number of parallel, orthogonal subchannels. FIG. 1 illustrates three such orthogonal subchannels or OFDM subcarriers in which each subcarrier is a peak which occurs at the null of the neighbouring channels.

While the overall data rate of the system is maintained, the data rate of each subchannel in an OFDM system is much less than this total rate. As a result, the duration of a time-domain OFDM symbol is much longer than that of an equivalent single-carrier system. This increased symbol duration provides a greater level of robustness to inter-symbol interference. Indeed, in the implementation of an OFDM-based system, ISI can be completely eliminated through the use of a cyclic prefix.

It is possible to implement an OFDM-based system using a different radio for each individual subchannel. However, a much more efficient approach involves the use of the discrete Fourier transform (DFT) and its highly computationally efficient implementation, the fast Fourier transform (FFT). Using the FFT and its inverse, the IFFT, an OFDM system can be implemented using a single radio.

In a transmitter, an OFDM symbol is generated in the frequency domain where individual data symbols are allocated to each OFDM sub-carrier. This process is illustrated in FIG. 2.

The OFDM symbol is then transformed into the time domain using an IFFT. In the time domain, the OFDM symbol consists of a sequence of baseband signal samples. A cyclic prefix may be appended to the symbol and it is then upconverted to a suitable carrier frequency and transmitted.

As OFDM symbols are generated in the frequency domain by allocating data symbols to individual subcarriers, it is possible to directly manipulate the spectrum of an OFDM signal by controlling the allocation of those data symbols. One application of this approach permits the power spectrum of an OFDM signal to be “sculpted” simply by allocating zero-valued data symbols to certain subcarriers. FIGS. 3 and 4 illustrate the generation of an OFDM symbol sculpted in this way together with the power spectrum of the resulting signal captured from a spectrum analyzer.

It is this ability to directly manipulate the spectrum of an OFDM signal that enables the generation of artificial cyclostationary features or “cyclostationary signatures”.

Two drawbacks typically associated with cyclostationary signal analysis are the computational complexity and long observation times required. Cyclostationary signal analysis involves the cross correlation of versions of the same signal, shifted in time and/or frequency. In order to minimize random effects and obtain reliable analysis results, large data samples are required. Hence the long signal observation times. As large data samples are required, large numbers of correlation computations must be performed. The computational complexity typically associated with cyclostationary signal analysis arises as a result of these correlation computations.

The invention is directed towards achieving an improved method and system for generation and detection of cyclostationary signatures.

### REFERENCES

[1] Cyclostationarity: Half a century of research, Gardner, W. A., Napolitano, A., Paura, L., Signal Processing, Elsevier, Volume 86, Issue 4, April 2006, Pages 639-697.
[2] Gardner, W., “Measurement of Spectral Correlation”, IEEE Transactions on Acoustics, Speech and Signal Processing, vol. 34, no. 5, October 1986.
[3] W. A. Gardner. INTRODUCTION TO RANDOM PROCESSES WITH APPLICATIONS TO SIGNALS AND SYSTEMS. Second edition. (Book) McGraw-Hill Publishing Company, New York, 546 pages, 1990
[4] Gardner, W. A.; Spooner, C. M., “Signal interception: performance advantages of cyclic-feature detectors,” Communications, IEEE Transactions on, vol. 40, no. 1, pp. 149-159, January 1992

### SUMMARY OF THE INVENTION

According to the invention, there is provided a method of multi-carrier data communication performed by a transmitter and a receiver, the method comprising the steps of:
the transmitter, in the frequency domain, repeating some data at a frequency separation to provide an artificial cyclostationary signature at one or more specific cyclic frequencies;
the transmitter converting the signal to the time domain and transmitting, and
the receiver receiving the signal and processing it in a bandwidth encompassing the cyclic frequencies.

In one embodiment, the transmitter applies at least two frequency separations in order to create a signature with at least two independent cyclostationary features.

In one embodiment, the receiver determines the cyclic frequency of the artificial cyclostationary signature by analysing the full range of possible values.

In one embodiment, the receiver is pre-set with knowledge of the cyclic frequency or a subset of possible values.

In one embodiment, the receiver processes the received signal in the frequency domain.

In one embodiment, the receiver processes the received signal in the time domain.

In another embodiment, the receiver uses presence of an artificial cyclostationary signature in the transmitted signal to perform detection of that signal.

In one embodiment, the receiver takes advantage of the presence of an artificial cyclostationary signature in the transmitted signal to perform physical layer configuration in order to successfully receive that signal.

In one embodiment, the receiver takes advantage of the presence of an artificial cyclostationary signature in the transmitted signal to identify the transmitter.

In one embodiment, the receiver takes advantage of the presence of an artificial cyclostationary signature in the transmitted signal to identify the network to which the transmitter belongs.

In one embodiment, the cyclic frequency of an embedded cyclostationary signature is used as a unique identifier.

In one embodiment, the spectral frequency of an embedded cyclostationary signature is used as a unique identifier.

In one embodiment, both the cyclic frequency and spectral frequency of an embedded cyclostationary signature are used as a unique identifier.

In one embodiment, the receiver takes advantage of the presence of an artificial cyclostationary signature in the transmitted signal to estimate the carrier frequency of that signal and perform frequency synchronization.

Preferably, the receiver takes advantage of the presence of an artificial cyclostationary signature in the transmitted signal to estimate the bandwidth of that signal.

In one embodiment, the receiver uses presence of an artificial cyclostationary signature in the transmitted signal to achieve network rendezvous.

In one embodiment, the transmitter operates using an OFDM transmission scheme.

In another aspect, the invention provides a data transmitter and a data receiver, wherein:
the transmitter is adapted to, in the frequency domain, repeat some data at a frequency separation to provide an artificial cyclostationary signature at one or more specific cyclic frequencies;
the transmitter is adapted to convert the signal to the time domain and transmitting said data, and
the receiver is adapted to receive the signal and process it in a bandwidth encompassing the cyclic frequencies.

In a further aspect, the invention provides a computer readable medium comprising program instructions which when executed by processors cause the processors to perform the steps of:
in the frequency domain, repeat some data at a frequency separation to provide an artificial cyclostationary signature at one or more specific cyclic frequencies, convert the signal to the time domain, and direct transmission of said signal, and
process a received signal in a bandwidth encompassing the cyclic frequencies.

### BRIEF DESCRIPTION OF THE DRAWINGS

The invention will be more clearly understood from the following description of some embodiments thereof, given by way of example only with reference to the accompanying drawings in which:—

FIGS. 1 to 4 are plots representative of the prior art, as set out above;

FIG. 5 is a diagram illustrating the generation of a cyclostationary signature (“watermark”) of the invention;

FIG. 6 is the cyclic spectrum of a communications signal containing a watermark;

FIG. 7 shows the spectral frequency of a watermark-containing signal at the cyclic frequency of that particular watermark;

FIG. 8 is a diagram of a communication system of the invention;

FIG. 9 is a diagram showing implementation of the time-smoothed cyclic cross periodogram (TSCCP);

FIG. 10 is a diagram showing watermark detection and analysis based on use of the TSCCP;

FIG. 11 is a diagram showing an alternative approach for watermark detection and analysis based on use of a time-shifting detector;

FIG. 12 is a diagram showing the cyclic spectrum of a communications signal containing a highlighted watermark at a particular cyclic frequency and spectral frequency location;

FIG. 13 is a diagram showing the cyclic spectrum of a communications signal containing a highlighted watermark at a different cyclic frequency and spectral frequency location; and

FIG. 14 is a diagram illustrating the generation of a multiple-feature cyclostationary signature (“watermark”) of the invention.

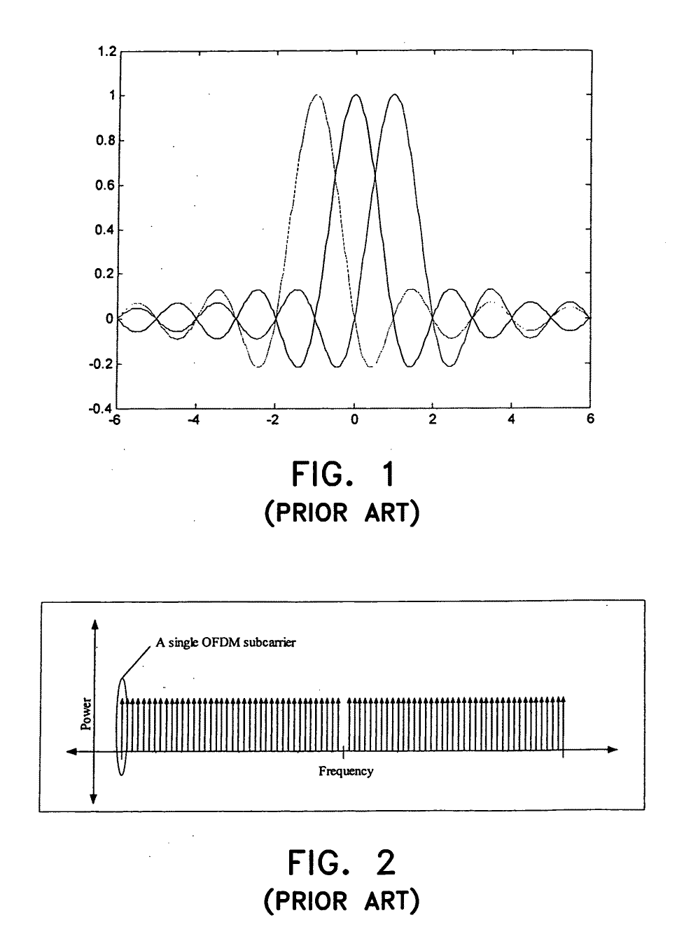

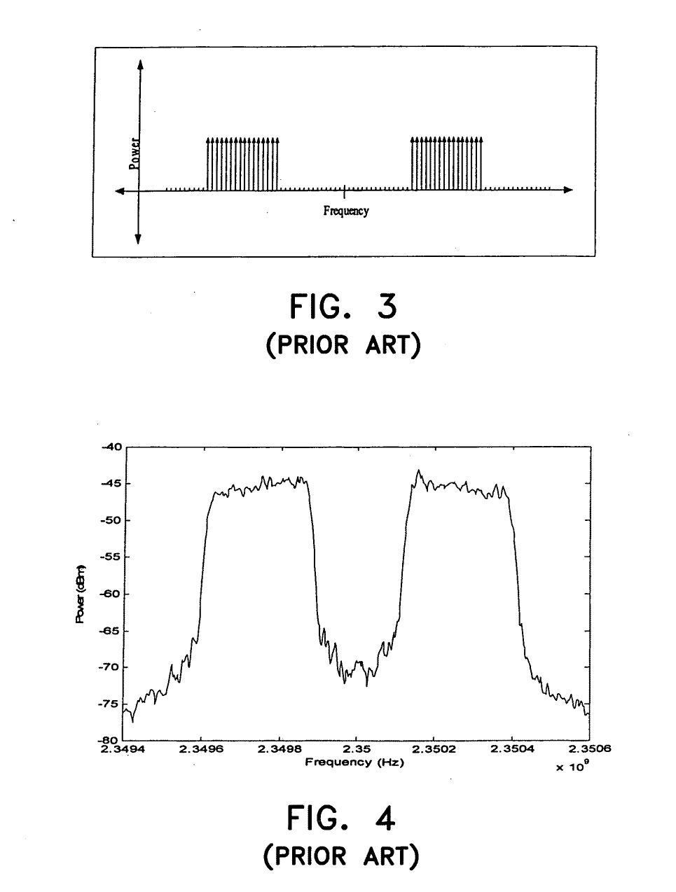

### DESCRIPTION OF THE EMBODIMENTS

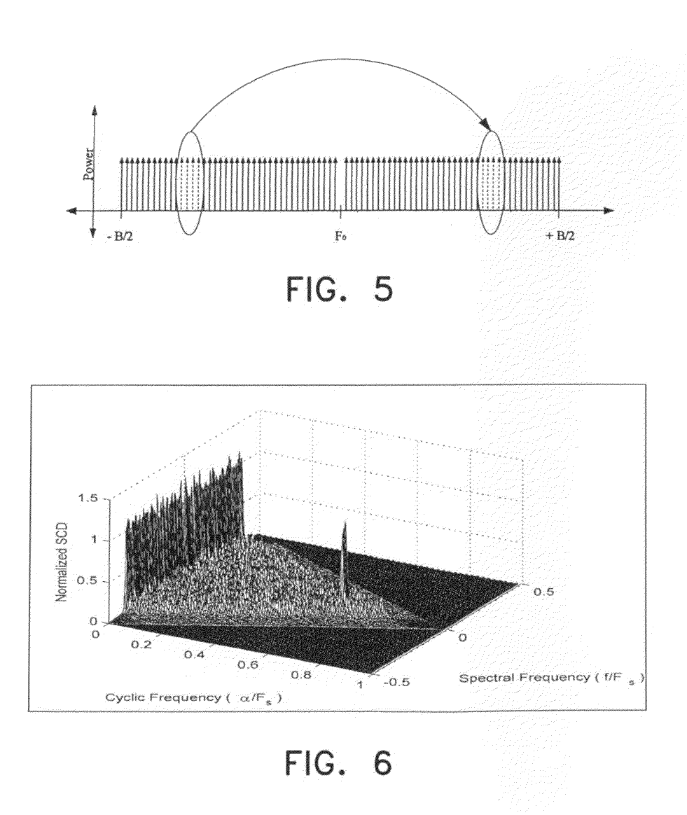

The invention provides a method and system for cyclostationary signature insertion and detection. FIG. 5 illustrates the manner in which a cyclostationary signature is artificially created in a multi-carrier signal in one embodiment. In this example, a multi-carrier Orthogonal Frequency Division Multiplexing (OFDM) signal is used. The approach involves mapping a set of one or more of the sub-carriers onto a second set such that any data symbols transmitted on the first set are simultaneously transmitted on the second set. In this way, those spectral components of the signal will be identical and a spectral correlation pattern will have been created. This spectral correlation pattern comprises the cyclostationary signature.

FIG. 6 illustrates the cyclic spectrum of a signal containing an embedded cyclostationary feature generated in this way. In this figure, the power spectrum of the signal can be seen at spectral frequency α=0. The embedded cyclostationary feature can be seen at cyclic frequency α=0.6. Only the positive cyclic frequencies are shown.

An artificial cyclostationary signature embedded in this way is continuously present in the transmitted data-carrying signal and so can be considered a type of signal watermark. By detecting and examining this watermark, a communications receiver can determine key properties of the signal and use those properties to achieve a number of critical tasks.

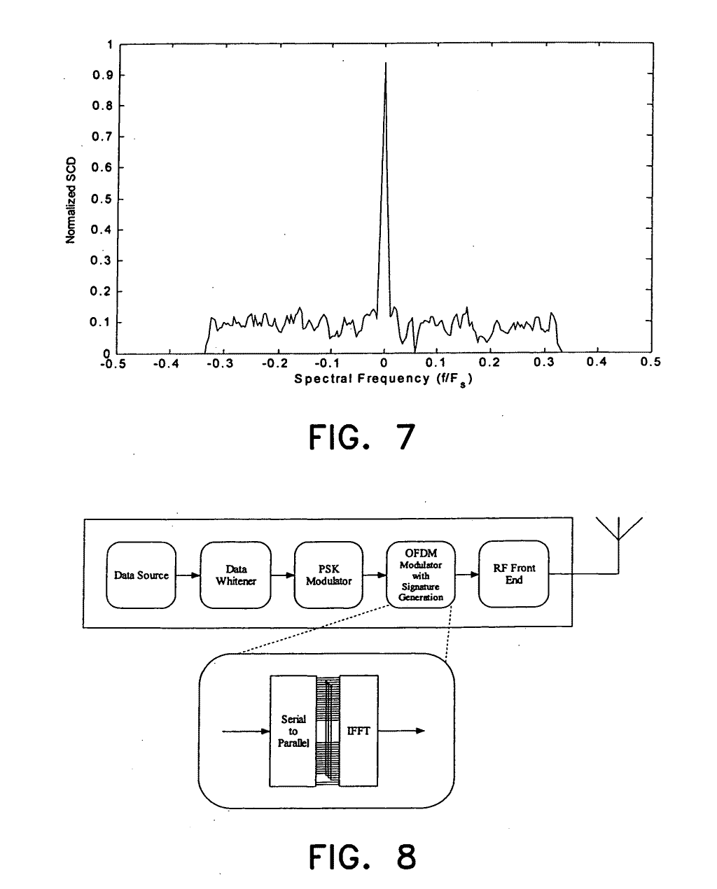

Using this sub-carrier mapping, a cyclostationary feature is intentionally generated at one or more specific cyclic frequencies. In the case where a receiver does not have prior knowledge of these cyclic frequencies, analysis must be performed across the full range of possible values. However, in the case where a receiver has prior knowledge of the cyclostationary signatures being used, its computational complexity may be significantly reduced simply by performing analysis at these specific cyclic frequencies, rather than over the full range of possible values. FIG. 7 shows the cyclostationary analysis of a signal at the cyclic frequency of an embedded cyclostationary signature. This embedded signature can be seen clearly at spectral frequency f=0.

As mentioned above, in order to achieve reliable cyclostationary signal analysis, large data samples are required. As a result, long signal observation times must typically be employed. Gardner [2] showed that a direct relationship exists between the length of the data samples required for reliable analysis and the spectral frequency resolution required to resolve the cyclostationary features of the signal. Specifically, it was shown that the temporal-spectral resolution product must greatly exceed unity:

Δf·Δt>>1

This means that as the spectral resolution required to resolve signal features decreases, the observation time required for reliable analysis increases, and vice versa.

Cyclostationary signal features which arise as by-products of the generation process typically require small spectral resolution to be resolved. However, cyclostationary features intentionally embedded using subcarrier mapping may typically be resolved using a much greater spectral frequency. As a result, a much shorter signal observation time is required to achieve reliable feature analysis.

Subcarrier mapping provides a very low complexity approach for generating cyclostationary signatures in multi-carrier waveforms and can be incorporated in current multi-carrier transmitters using minor modifications. FIG. 8 illustrates an example OFDM transmitter, using subcarrier mapping to embed an artificial cyclostationary signature. Within the OFDM modulator of the transmitter, data symbols are mapped prior to the inverse fast Fourier transform, resulting in the creation of a spectrum correlation which constitutes the embedded cyclostationary signature.

Subcarrier mapping provides a highly effective technique for embedding a cyclostationary signature or watermark in a transmitted multi-carrier signal. However, in order to take advantage of the presence of such a watermark in a communications receiver, it must be possible to perform detection and analysis of that watermark.

In developing algorithms for the detection and analysis of cyclostationary signatures, we have chosen to focus on a time-smoothing approach. It should be noted however, that an equivalent frequency-smoothing approach could be taken.

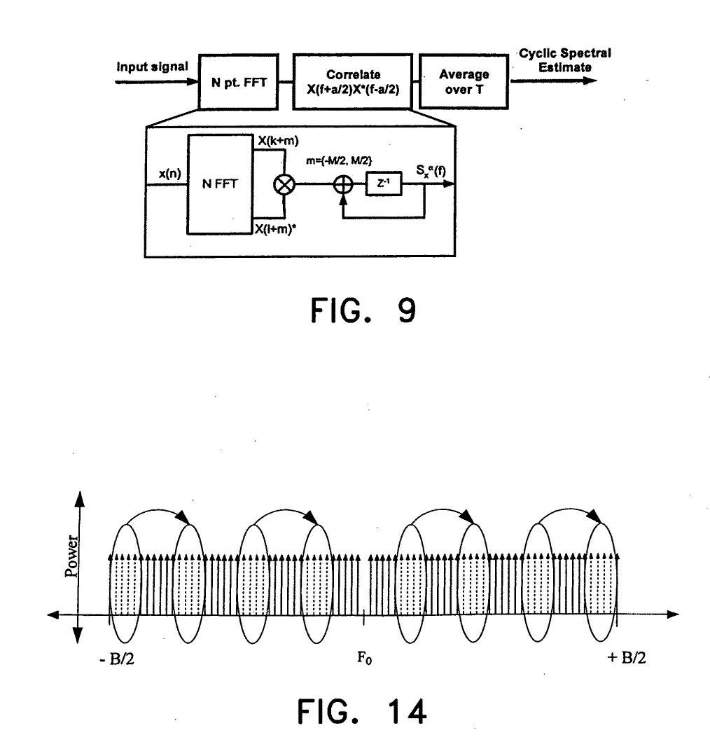

The basis for all time-smoothing algorithms is the time-smoothed cyclic cross periodogram (TSCCP). FIG. 9 illustrates an implementation of this algorithm. In developing our watermark detection and analysis algorithm, we have used the TSCCP as our starting point. FIG. 10 illustrates our algorithm for the detection and analysis of signals containing watermarks.

Using the TSCCP, the cyclic spectrum of a signature-containing signal can be estimated at the specific cyclic frequency of that signature. The cyclic spectrum coefficient is obtained through normalization with the signal power. This results in the signal autocoherence function [3] which is bounded in the range {0,1}.

Once we have estimated the cyclic spectrum at the cyclic frequency of the signature, we can perform detection and analysis of the signature features. Thresholding is used for feature detection. Signature analysis will depend upon the particular application in question. For example, in order to perform carrier frequency estimation, the spectral frequencies at which signature features occur are examined. In the case of bandwidth estimation using multiple embedded features, the number and spectral frequency locations of these features are examined.

The basic algorithm for the detection and analysis of watermarks uses frequency domain shifting of the signal in order to estimate the cyclic spectrum. However, this frequency shift can also be performed in the time domain through multiplication with a complex exponential time series. The advantage of this approach is that it provides much greater control over the value of the frequency shift and hence the resolution of cyclic frequencies which can be examined. This is achieved at the cost of additional computational complexity. This alternative algorithm for watermark detection and analysis is illustrated in FIG. 11.

### Uses of Cyclostationary Signatures

Having discussed the generation, detection and analysis of cyclostationary signatures, this section addresses a number of ways in which these signatures or watermarks can be used in communication systems. For each application, details of the way watermarks can be used are provided.

Signal Detection

It has been shown that signal detection methods based upon cyclostationary signal analysis provide significant performance improvements over alternative energy detection approaches [4]. In order to use cyclostationary signal analysis to detect a signal, that signal must contain cyclostationary features. Most signals used in communication systems contain inherent cyclostationary features as a by-product of the signal generation process. However in order to reliably resolve and detect these inherent features, a detector must typically employ a small frequency resolution and hence a long signal observation time. A cyclostationary signature or watermark is a cyclostationary feature which can be intentionally embedded in a communications signal. Unlike inherent cyclostationary features, a signature intentionally embedded using subcarrier mapping can be detected using a relatively large frequency resolution and hence a relatively short signal observation time.

One example of a situation where cyclostationary signatures can be used in this way is secondary spectrum use for wireless communications networks. Communications regulators worldwide are currently considering more flexible approaches to spectrum management in an effort to improve the efficiency with which spectrum is used. These approaches include the possibility of secondary spectrum usage. Under this scenario a Primary user is a network which has priority access to a given frequency band. A Secondary user is a network which may access the same frequency band, but only when the Primary user is not making use of it. If a Secondary user is using the band and detects the return of a Primary user, it must vacate that band immediately and leave it to the higher priority Primary user. A significant challenge associated with this scenario is the reliable detection of Primary networks by members of Secondary networks. In order to perform reliable detection, it must be possible to detect Primary user signals at very low powers.

In the case of secondary spectrum usage, a Primary user can make it easier for a Secondary user to detect its transmissions by embedding a cyclostationary signature in those transmissions. In this way, the Secondary user can perform cyclostationary signal analysis in order to detect that signature and can thus reliably detect the Primary user using a relatively large frequency resolution and hence a relatively short signal observation time.

Physical Layer Configuration/Network Identification

Communication systems designed for different operating environments typically operate using parameters specifically suited to those environments. These parameters can include signal waveforms, transmission protocols and carrier frequencies among others. In the past, wireless devices were designed to operate in just one network, using a fixed set of operating parameters. Current devices such as mobile phones often support a number of network types simply by featuring a number of independent radios. However, in the future, devices may be capable of operating within a wide range of network types using just a single radio by dynamically reconfiguring the basic operating parameters of this radio. These reconfigurable radios are being made possible by advances in the areas of digital signal processing and software-defined radio.

Consider the case where a reconfigurable radio is capable of operating as a member of a number of different communication systems through dynamic parameter reconfiguration. However, the radio may not have prior knowledge about the systems operating within a given frequency band and geographic area.

A cyclostationary signature is a form of watermark which can be embedded in a data-carrying multi-carrier communication signal through subcarrier mapping. The spectral and cyclic frequencies at which this watermark is generated can be directly specified by the device which transmits the signal. By choosing to generate a signature at a unique spectral or cyclic frequency, a device can use that signature as a unique identifier. FIG. 12 and FIG. 13 show the cyclic spectra for two signals. In the first, the mapped subcarriers have been carefully chosen to create a signature or watermark at a particular cyclic frequency and spectral frequency location. In the second, a different set of subcarriers have been mapped in order to generate the watermark at a different cyclic frequency and spectral frequency location. In the case of these two signals, each can be uniquely identified using cyclic frequency location, the spectral frequency location, or indeed both the cyclic and spectral frequency locations, of the embedded watermark.

All devices within a network can identify themselves as members of that network by embedding a common cyclostationary signature in all transmitted signals. If different networks employ unique signatures, these signatures can then be used to perform network identification.

A reconfigurable radio wishing to join a network can discover the networks which are operating within a given frequency band and geographic area using cyclostationary signatures embedded in the transmissions of devices belonging to those networks. To do this, the device scans a frequency band for signals containing signatures which it recognizes. If a signature is recognized, it can be used to determine the communication system operating at that location. Using this information, the radio can then adapt its own operating parameters to that of the recognized system in order to join it. If multiple signatures are recognized in the given frequency band, the reconfigurable radio can choose the network which best suits its needs at that time, adapt to the parameters of that network and join.

Frequency Acquisition

In order to successfully receive a communications signal, a device must determine the carrier frequency of that signal, acquire the signal and perform frequency synchronization.

The spectral frequencies of signature features intentionally embedded in a signal using subcarrier mapping are directly related to the carrier frequency of that signal. If a device can detect these embedded features and estimate their spectral frequencies, it can determine the carrier frequency of the signal and use that information to achieve frequency synchronization.

FIG. 7 shows the spectral frequency of a detected cyclostationary signature. In this case, the embedded cyclostationary feature is centred at the carrier frequency of the signal and can be used to directly estimate the signal carrier frequency.

Multi-Feature Signatures for Multi-Path Robustness

Subcarrier mapping can be used to embed a single cyclostationary feature in a communications signal. However, by mapping more than one set of sub-carriers, multiple features can be embedded in a single signal. In this way, a cyclostationary signature can comprise more than one feature, embedded at one or more spectral and cyclic frequencies.

One reason why this might be done is to provide robustness under multi-path fading conditions. Multi-path arises when a communications signal follows more than one path to a receiver. As a result, more than one copy of a signal may be received, each with a different delay and signal strength. This can give rise to frequency-selective fading, where certain frequencies are attenuated much more than others. In the case where a deep fade occurs at the frequency of a mapped set of sub-carriers, the resulting cyclostationary signature can be severely distorted. By embedding multiple cyclostationary features, each at a different spectral frequency, robustness against multi-path and frequency-selective fading can be achieved.

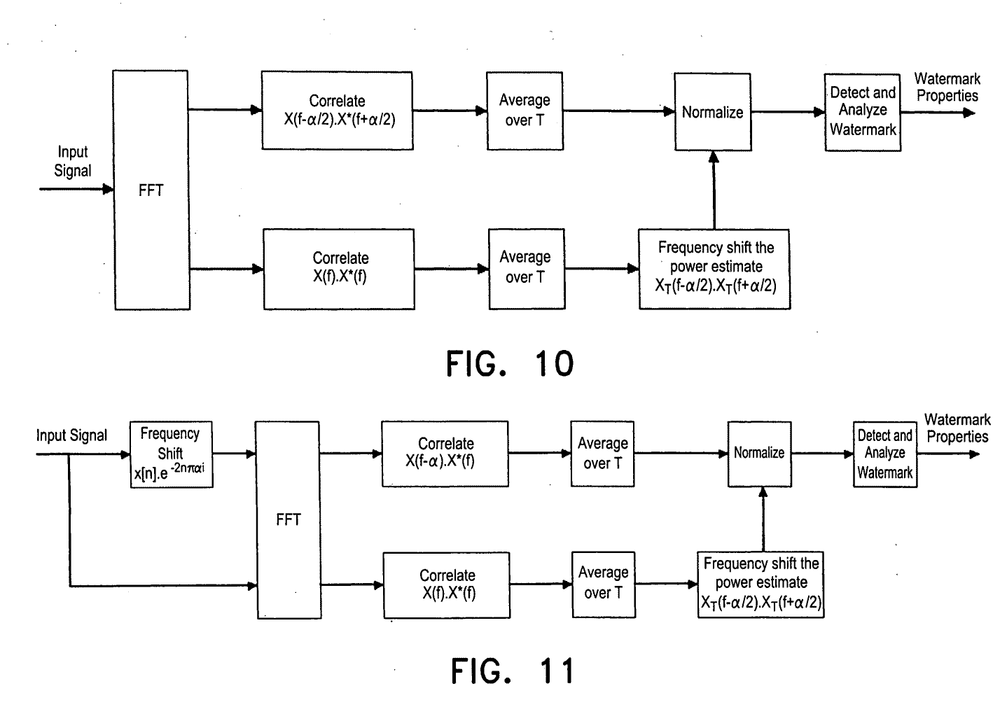

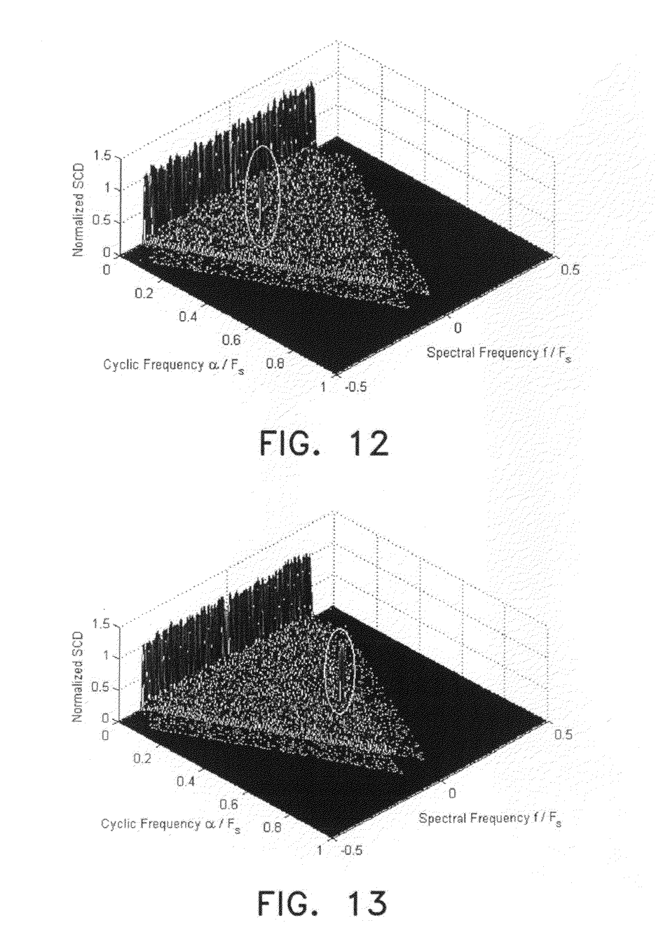

FIG. 14 shows one way in which a multiple-feature cyclostationary signature can be generated. In this example, more than one subcarrier set is mapped and each mapping gives rise to an independent feature located at a common cyclic frequency but at different spectral frequencies.

Signal Bandwidth Estimation.

Another use of multiple-feature cyclostationary signatures is in achieving signal bandwidth estimation.

Consider the case where a reconfigurable radio wishes to receive a signal transmitted by a peer but does not know what the bandwidth of that signal is. Using subcarrier mapping, cyclostationary features can be embedded in a transmitted signal at a specific cyclic frequency and at a specific spectral frequency.

Consider the case where a transmitter can dynamically choose the bandwidth of the signal it wants to transmit. One way of achieving this is to define a minimum unit of bandwidth which can be used. Using one or more of these bandwidth units, signals with variable bandwidths can be generated and transmitted.

Now consider that within each bandwidth unit, a cyclostationary signature is embedded using sub-carrier mapping. In this way, a signal comprising multiple bandwidth units will contain multiple independent signatures.

In order to estimate the bandwidth of such a signal, a receiver can use cyclostationary signal analysis to detect each of the individual signatures. By examining the signatures detected, the overall bandwidth of the received signal can be estimated.

Network Rendezvous

When a wireless communications device becomes active, it needs to create a communications link with peer devices and become a member of a network. If the operating parameters being used by peer devices are known in advance, communications links can be established by setting the receiver operating parameters to match those of peers. However, if those operating parameters are not known in advance, the device must have some method of discovering them.

This mechanism may involve one or more of the applications of cyclostationary signatures already discussed including signal detection, waveform recognition, network identification, frequency acquisition and bandwidth estimation.

Consider a scenario where all devices in a particular network embed a common watermark in their transmitted signals. A device which needs to discover the operating parameters being used by peer devices of the network can use its receiver to scan across frequencies and detect that watermark. Upon detection of a watermark, the device can identify the transmitter as a member of that particular network. The device can also use the detected watermark to estimate the carrier frequency and the bandwidth of the received signal. Using this information, the device can successfully synchronize with and receive the signal in order to establish a communications link and join the network.

The invention is not limited to the embodiments described but may be varied in construction and detail. For example, the invention may be applied to a multi-carrier scheme other than OFDM, for example a discrete multi-tone (DMT) scheme. Also, architectures used to detect and analyze embedded cyclostationary signatures may vary from the time-smoothed architecture described herein. For example, a frequency-smoothed approach may be employed or an architecture for time-domain signature detection may be used.

1. A method of multi-carrier data communication performed by a transmitter and a receiver, the method comprising the steps of:
the transmitter, in the frequency domain, repeating some data at a frequency separation to provide an artificial cyclostationary signature at one or more specific cyclic frequencies;
the transmitter converting the signal to the time domain and transmitting, and
the receiver receiving the signal and processing it in a bandwidth encompassing the cyclic frequencies.

2. A method as claimed in claim 1, wherein the transmitter applies at least two frequency separations in order to create a signature with at least two independent cyclostationary features.

3. A method as claimed in claim 1, wherein the receiver determines the cyclic frequency of the artificial cyclostationary signature by analysing the full range of possible values.

4. A method as claimed in claim 1, wherein the receiver is pre-set with knowledge of the cyclic frequency or a subset of possible values.

5. A method as claimed in claim 1, wherein the receiver processes the received signal in the frequency domain.

6. A method as claimed in claim 1, wherein the receiver processes the received signal in the time domain.

7. A method as claimed in claim 1, wherein the receiver uses presence of an artificial cyclostationary signature in the transmitted signal to perform detection of that signal.

8. A method as claimed in claim 1, wherein the receiver takes advantage of the presence of an artificial cyclostationary signature in the transmitted signal to perform physical layer configuration in order to successfully receive that signal.

9. A method as claimed in claim 1, wherein the receiver takes advantage of the presence of an artificial cyclostationary signature in the transmitted signal to identify the transmitter.

10. A method as claimed in claim 1, wherein the receiver takes advantage of the presence of an artificial cyclostationary signature in the transmitted signal to identify the network to which the transmitter belongs.

11. A method as claimed in claim 1, wherein the cyclic frequency of an embedded cyclostationary signature is used as a unique identifier.

12. A method as claimed in claim 1, wherein the spectral frequency of an embedded cyclostationary signature is used as a unique identifier.

13. A method as claimed in claim 1, wherein both the cyclic frequency and spectral frequency of an embedded cyclostationary signature are used as a unique identifier.

14. A method as claimed in claim 1, wherein the receiver takes advantage of the presence of an artificial cyclostationary signature in the transmitted signal to estimate the carrier frequency of that signal and perform frequency synchronization.

15. A method as claimed in claim 1, wherein the receiver takes advantage of the presence of an artificial cyclostationary signature in the transmitted signal to estimate the bandwidth of that signal.

16. A method involving one claim 1, wherein the receiver uses presence of an artificial cyclostationary signature in the transmitted signal to achieve network rendezvous.

17. A method as claimed in claim 1, wherein the transmitter operates using an OFDM transmission scheme.

18. A data transmitter and a data receiver, wherein:
the transmitter is adapted to, in the frequency domain, repeat some data at a frequency separation to provide an artificial cyclostationary signature at one or more specific cyclic frequencies;
the transmitter is adapted to convert the signal to the time domain and transmitting said data, and
the receiver is adapted to receive the signal and process it in a bandwidth encompassing the cyclic frequencies.

19. A computer readable medium comprising program instructions which when executed by processors cause the processors to perform the steps of:
in the frequency domain, repeat some data at a frequency separation to provide an artificial cyclostationary signature at one or more specific cyclic frequencies, convert the signal to the time domain, and direct transmission of said signal, and
process a received signal in a bandwidth encompassing the cyclic frequencies.
